(19) United States
(12) Patent Application Publication
(10) Pub. No.: US 2006/0276994 A1
(43) Pub. Date: Dec. 7, 2006

(54) Data analysis method and recording medium recording data analysis program

(75) Inventors: Hidetaka Tsuda, Kawasaki (JP); Hidehiro Shirai, Kawasaki (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/236,716

(22) Filed: Sep. 28, 2005

(30) Foreign Application Priority Data
Jun. 1, 2005 (JP) 2005-161395

(51) Int. Cl. G06F 17/18; G06F 19/00; G06F 15/00

(52) U.S. Cl. 702/179

(57) ABSTRACT

A data analysis method allows a correlation between variables to be efficiently extracted from a record group. A record group sort unit of a computer sorts the target record group by the magnitude of a specified variable, for instance. A record group divide-and-extract unit divides the sorted target record group in a specified dividing manner (four-part division or eight-part division, for instance) and extracts subordinate record groups. A correlation calculation unit calculates a correlation between specified variables in each of the subordinate record groups.

### CROSS-REFERENCE TO RELATED APPLICATIONS

This application is based upon and claims the benefits of priority from the prior Japanese Patent Application No. 2005-161395, filed on Jun. 1, 2005, the entire contents of which are incorporated herein by reference.

### BACKGROUND OF THE INVENTION

1. Field of the Invention

The present invention relates to data analysis methods and recording media recording data analysis programs, and particularly to a data analysis method and a recording medium recording a data analysis program for extracting a correlation among data.

2. Description of the Related Art

High volumes of diverse data are stored in computer systems in the semiconductor manufacturing industry and many other industries. These data serve no purpose in business and make no profit if they are just accumulated. Under the circumstances, the industrial community has been interested in and has been frequently using data mining, a data analysis technique for finding useful regularities or characteristics out of the high volumes of diverse data efficiently for business use. Data mining has found extensive applications and has yielded practical results in industries such as finance and distribution. The semiconductor manufacturing industry and some other industries requiring process data analysis have begun using data mining in recent years.

A major purpose of process data analysis is to extract factors responsible for defective items, but those factors abound and get entangled in complexity. In process data analysis, all of the collected process data are usually analyzed. Even if two specific variables are correlated with each other, the correlation may often appear to be weak when either variable varies with any other variable. This type of hidden correlation is hard to find.

FIG. 51 is a table showing an example record group. The table lists records concerning a resistor. Each record includes a voltage applied to the resistor and a current passing through the resistor, measured by an apparatus A or B. The apparatus value, the current value, and the voltage value are variables.

FIG. 52 is a chart showing the correlation between two variables, the current value and the voltage value, among the records listed in FIG. 51. In FIG. 52, a black diamond indicates the correlation between the current value and the voltage value measured by the apparatus A. A black square (found in an ellipse E) indicates the correlation between the current value and the voltage value measured by the apparatus B. A line L52 represents a simple regression equation (simple regression function) of the two variables, the current value (x) and the voltage value (y), among all the records measured by the apparatuses A and B. The simple regression equation represented in the figure and the contribution R² are expressed as follows:
y=0.292x+5.1712
R²=0.1496
where R is a correlation coefficient.

FIG. 53 is a table listing records having an apparatus value B, among the records listed in FIG. 51. FIG. 54 is a chart showing the correlation between the two variables, the current value and the voltage value, among the records listed in FIG. 53. A line L54 in FIG. 54 represents a simple regression equation of the two variables, the current value (x) and the voltage value (y), among the records listed in FIG. 53. The simple regression equation represented in the figure and the contribution R² are expressed as follows:
y=0.7235x+2.4705
R²=0.9278

The chart of FIG. 52 does not show a strong correlation between the current value and the voltage value although the two variables should have a strong linear correlation, according to Ohm's law. Because the accumulated data were obtained under various environmental conditions, the correlation between the two variables varies greatly as shown in FIG. 52. The correlation which should be observed here is hidden. When the record group is divided into a group of records having an apparatus value A and a group of records having an apparatus value B, it can be found that the latter record group has a strong correlation between the current value and the voltage value, as shown in FIG. 54.

The technique of dividing a record group into strata according to characteristics is referred to as stratification, and the technique is often used. (In the example described above, a stratum of records having an apparatus value A and a stratum of records having an apparatus value B are formed.)

On the basis of these results of data analysis, it can be concluded that conditions concerning the apparatus A vary and hide the correlation which should be observed, and therefore the apparatus A was faulty. The gradient a and the intercept b of the simple regression equation y=ax+b and the contribution R² can be obtained by using commercial spreadsheet software. Those values enable the correlation to be evaluated quantitatively.

Each data record generally includes a large number of variables. Efficient extraction of a correlation between variables is an important factor for increasing the effectiveness of data analysis. Some types of correlations can be found between variables after the record group is divided as described earlier.

A general technique to know in what respect the record group should be divided to find a correlation between variables efficiently has not yet been established. The present applicant has disclosed a technique of limited application (see Japanese Unexamined Patent Application Publication No. 2001-306999, for instance). The technique uses the regression tree analysis, a technique of data mining, to find a factor which has the largest effect on yield, divides the records by eliminating a record satisfying the condition, and extracts a hidden correlation from the data. The technique is the most unfailing way to extract a correlation efficiently by dividing a record group.

Some correlations between variables can be found by dividing a record group as described above although a general technique to know in what respect the record group should be divided to find a correlation between variables efficiently has not yet been established. The correlation may not always be found among contiguous records, and discontiguous records may have a strong correlation. An efficient technique for extracting a correlation between variables from the record group has been desired.

### SUMMARY OF THE INVENTION

In view of the foregoing, it is an object of the present invention to provide a data analysis method and a medium recording a data analysis program for extracting a correlation between variables from a record group efficiently.

To accomplish the above object, according to the present invention, there is provided a data analysis method for extracting a correlation among data. This data analysis method includes the following steps: a record group sort step of sorting a target record group by a specified variable, a record group divide-and-extract step of dividing the sorted target record group in a specified dividing manner and extracting subordinate record groups, and a correlation calculation step of calculating a correlation between specified variables in each of the subordinate record groups.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows an overview of a data analysis method.

FIG. 2 shows a general configuration of a data analysis apparatus for implementing the data analysis method.

FIG. 3 shows an execution control data input screen displayed on a display unit by an execution control data input program.

FIG. 4 is a flow chart showing a procedure of data analysis performed by the data analysis apparatus.

FIG. 5 shows a target record group of data analysis.

FIG. 6 shows a record group obtained by sorting the record group shown in FIG. 5 by time.

FIG. 7 shows the trend of a channel length in the record group shown in FIG. 6.

FIG. 8 shows the trend of a threshold voltage in the record group shown in FIG. 6.

FIG. 9 shows the trend of a yield in the record group shown in FIG. 6.

FIG. 10 is a first chart showing the correlation between the channel length and the yield in the record group shown in FIG. 6.

FIG. 11 is a first chart showing the correlation between the threshold and the yield in the record group shown in FIG. 6.

FIG. 12 is a second chart showing the correlation between the channel length and the yield in the record group shown in FIG. 6.

FIG. 13 is a second chart showing the correlation between the threshold and the yield in the record group shown in FIG. 6.

FIG. 14 is a third chart showing the correlation between the channel length and the yield in the record group shown in FIG. 6.

FIG. 15 is a third chart showing the correlation between the threshold and the yield in the record group shown in FIG. 6.

FIG. 16 is a fourth chart showing the correlation between the channel length and the yield in the record group shown in FIG. 6.

FIG. 17 is a fourth chart showing the correlation between the threshold and the yield in the record group shown in FIG. 6.

FIG. 18 is a fifth chart showing the correlation between the channel length and the yield in the record group shown in FIG. 6.

FIG. 19 is a fifth chart showing the correlation between the threshold and the yield in the record group shown in FIG. 6.

FIG. 20 is a sixth chart showing the correlation between the channel length and the yield in the record group shown in FIG. 6.

FIG. 21 is a sixth chart showing the correlation between the threshold and the yield in the record group shown in FIG. 6.

FIG. 22 is a seventh chart showing the correlation between the channel length and the yield in the record group shown in FIG. 6.

FIG. 23 is a seventh chart showing the correlation between the threshold and the yield in the record group shown in FIG. 6.

FIG. 24 shows a record group obtained by sorting the record group shown in FIG. 5 by the resistance value.

FIG. 25 shows the trend of the channel length in the record group shown in FIG. 24.

FIG. 26 shows the trend of the threshold voltage in the record group shown in FIG. 24.

FIG. 27 shows the trend of the yield in the record group shown in FIG. 24.

FIG. 28 is a first chart showing the correlation between the channel length and the yield in the record group shown in FIG. 24.

FIG. 29 is a first chart showing the correlation between the threshold and the yield in the record group shown in FIG. 24.

FIG. 30 is a second chart showing the correlation between the channel length and the yield in the record group shown in FIG. 24.

FIG. 31 is a second chart showing the correlation between the threshold and the yield in the record group shown in FIG. 24.

FIG. 32 is a third chart showing the correlation between the channel length and the yield in the record group shown in FIG. 24.

FIG. 33 is a third chart showing the correlation between the threshold and the yield in the record group shown in FIG. 24.

FIG. 34 is a fourth chart showing the correlation between the channel length and the yield in the record group shown in FIG. 24.

FIG. 35 is a fourth chart showing the correlation between the threshold and the yield in the record group shown in FIG. 24.

FIG. 36 is a fifth chart showing the correlation between the channel length and the yield in the record group shown in FIG. 24.

FIG. 37 is a fifth chart showing the correlation between the threshold and the yield in the record group shown in FIG. 24.

FIG. 38 is a sixth chart showing the correlation between the channel length and the yield in the record group shown in FIG. 24.

FIG. 39 is a sixth chart showing the correlation between the threshold and the yield in the record group shown in FIG. 24.

FIG. 40 is a seventh chart showing the correlation between the channel length and the yield in the record group shown in FIG. 24.

FIG. 41 is a seventh chart showing the correlation between the threshold and the yield in the record group shown in FIG. 24.

FIG. 42 shows an example of division of the record group when automatic division is selected.

FIG. 43 shows an example of dividing the record group into 2⁰ parts, 2¹ parts, and 2² parts.

FIG. 44 shows the results of analysis of the record group divided as shown in FIG. 43.

FIG. 45 shows the results of analysis of the record group sorted by the resistance value and divided as shown in FIG. 43.

FIG. 46 shows an example of division when automatic division is not selected.

FIG. 47 shows the results of analysis of the record group divided as shown in FIG. 46.

FIG. 48 shows the results of analysis of the record group sorted by the resistance value and divided as shown in FIG. 46.

FIG. 49 is a first table listing the results of analysis of the record group which has not been sorted.

FIG. 50 is a second table listing the results of analysis of the record group which has not been sorted.

FIG. 51 is a table showing an example record group.

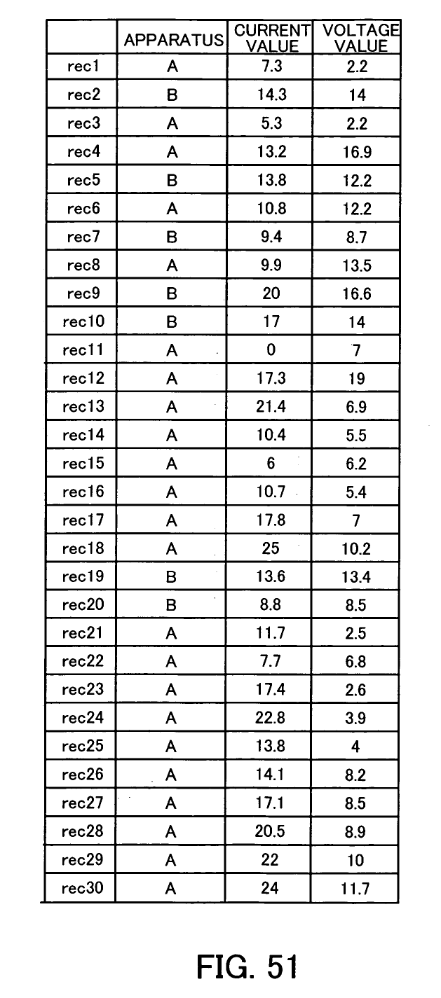

FIG. 52 is a chart showing the correlation between two variables, the current value and the voltage value, of the records listed in FIG. 51.

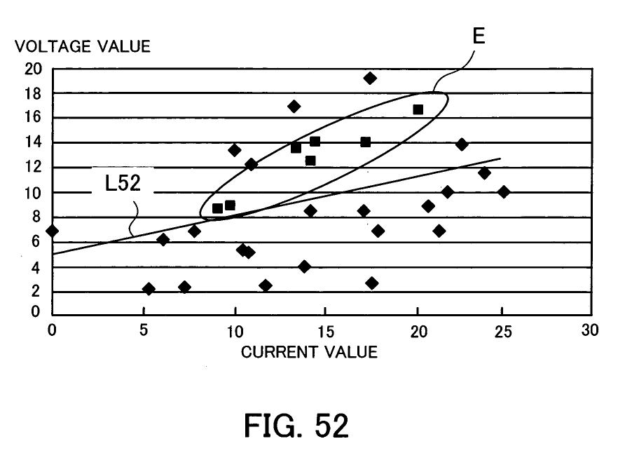

FIG. 53 is a table listing records having an apparatus value B, among the records listed in FIG. 51.

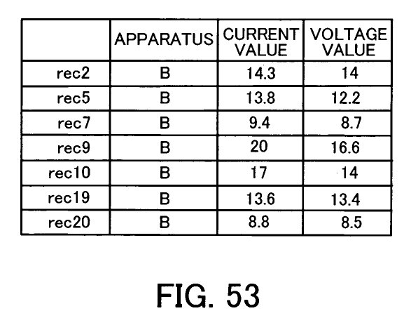

FIG. 54 is a chart showing the correlation between the two variables, the current value and the voltage value, of the records listed in FIG. 53.

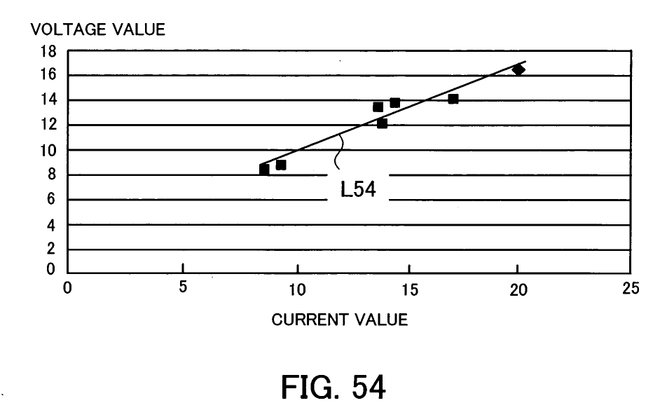

### DESCRIPTION OF THE PREFERRED EMBODIMENTS

The concept of the present invention will be described with reference to a drawing.

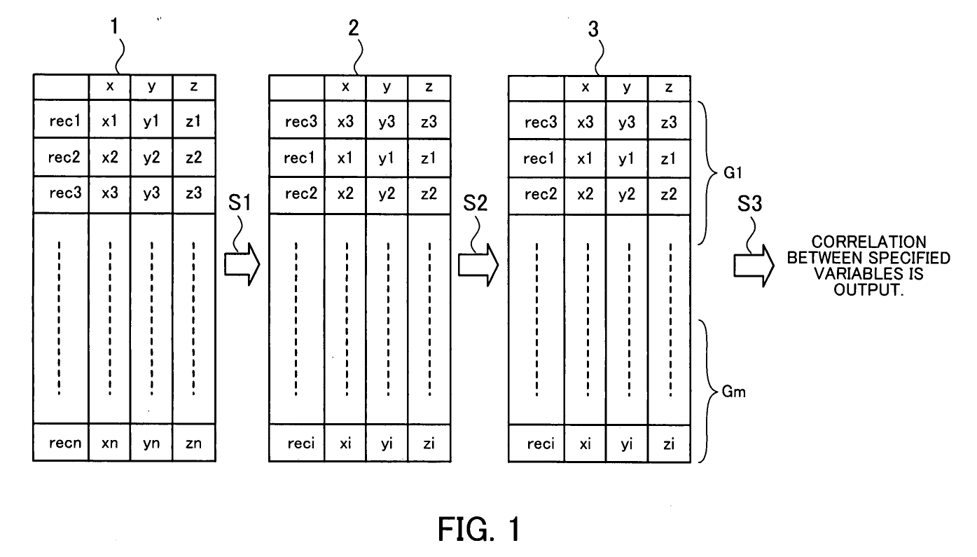

FIG. 1 shows an overview of data analysis. The figure shows a record group 1 from which a correlation should be extracted by a computer. The target record group 1 includes data items x1 to xn of a variable x, data items y1 to yn of a variable y, and data items z1 to zn of a variable z. References rec1 to recn represent the order in which the variables x, y, and z are recorded. For instance, reference reel indicates that data items x1, y1, and z1 are recorded. Target record groups 2 and 3 are obtained in the course of processing performed on the target record group 1 until a correlation is found. The computer has a record group sort unit, a record group divide-and-extract unit, and a correlation calculation unit, which are not shown, and extracts a correlation from the target record group 1.

The record group sort unit of the computer sorts the target record group 1 by a specified variable x, y, or z. If the variable x is specified, the target record group 1 is sorted in order of ascending magnitude of the variable x. The shown example has a relationship of x3<x1<x2, and rec1 to recn are sorted accordingly.

The record group divide-and-extract unit divides the sorted target record group 2 in a specified dividing manner and extracts subordinate record groups G1 to Gm. If four-part division is specified, rec1 to reci are divided into four groups.

The correlation calculation unit calculates the correlation between specified variables in each of the subordinate record groups G1 to Gm. If the variables x and y are specified, the correlation between the variables x and y is calculated in each of the subordinate record groups G1 to Gm.

The target record group 1 is sorted by a specified variable x, y, or z and divided into subordinate record groups G1 to Gm in a specified manner, and the correlation between specified variables is calculated in each of the subordinate record groups G1 to Gm. Accordingly, a correlation between variables can be efficiently extracted from a record group.

Some types of correlations cannot be extracted if all the records of the target record group 1 are analyzed, but the present invention makes it easy to extract those hidden correlations between variables from the record group. If the present data analysis method is used in the semiconductor manufacturing industry and some other industries requiring process data analysis, a factor responsible for defective items can be easily found, and superiority in the industry can be gained.

Embodiments of the present invention will be described in detail with reference to drawings.

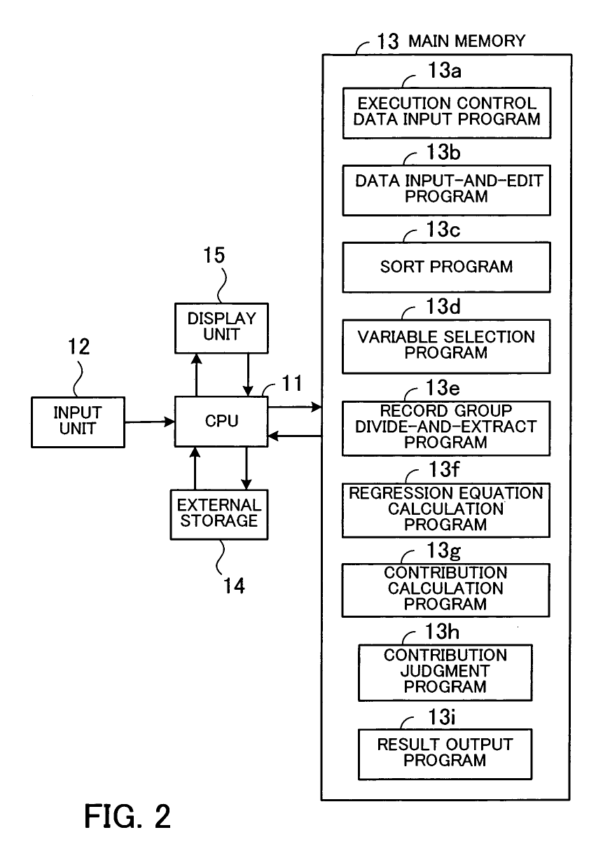

FIG. 2 shows a general configuration of a data analysis apparatus for implementing the present data analysis method. The data analysis apparatus includes a central processing unit (CPU) 11, an input unit 12, a main memory 13, an external storage 14, and a display unit 15.

The CPU 11 executes each piece of processing required for data analysis and the like. The input unit 12 receives execution control data needed for data analysis and the like. The main memory 13 holds the data to be analyzed and programs necessary for data analysis. The external storage 14 is used to store record groups, programs needed for data analysis, results of data analysis, and the like. The display unit 15 displays an execution control data input screen and the results of data analysis.

An execution control data input program 13a stored in the main memory 13 inputs execution control data required for data analysis. The execution control data is input from the input unit 12 through the execution control data input screen displayed on the display unit 15.

A data input-and-edit program 13b reads data specified as target data of data analysis from the external storage 14 and writes (inputs) the data into the main memory 13, and edits the input data into a record group if the data has not yet been edited. The target data of data analysis is specified in an input file specification box of the execution control data input screen.

A sort program 13c sorts a record group by a specified variable in the target record group of data analysis. The variable is specified in a sort variable specification box of the execution control data input screen.

A variable selection program 13d selects two variables from the specified variables in the target record group of data analysis, as the target of correlation calculation. The variables are specified in a variable specification field of the execution control data input screen.

A record group divide-and-extract program 13e divides the target record group of data analysis in a specified dividing manner and extracts subordinate record groups. The manner of dividing the target record group of data analysis is specified in a division specification field of the execution control data input screen.

A regression equation calculation program 13f calculates the gradient a and the intercept b of the simple regression equation y=ax+b held between the two selected variables in each of the subordinate record groups in a conventionally known method. A contribution calculation program 13g calculates the contribution R² of each of the subordinate record groups in a conventionally known manner.

A contribution judgment program 13h judges whether the contribution R² obtained by the contribution calculation program 13g is greater than or equal to a specified threshold. The threshold of the contribution R² is specified in an R² threshold specification box of the execution control data input screen.

A result output program 13i outputs the gradient a and the intercept b of the simple regression equation y=ax+b calculated by the regression equation calculation program 13f, the contribution R² and the like, displays the values on the display unit 15, and writes the values into the external storage 14.

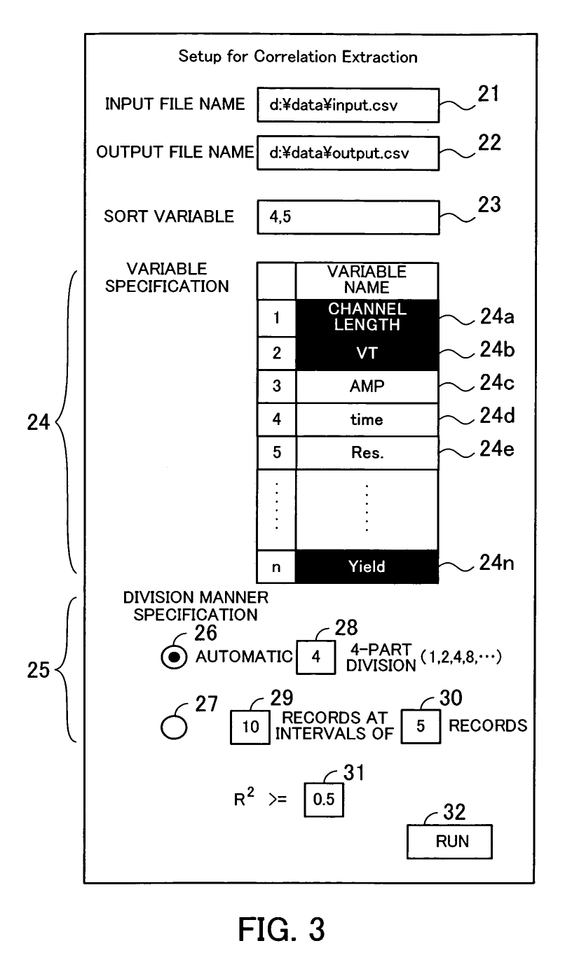

FIG. 3 shows the execution control data input screen displayed on the display unit 15 by the execution control data input program. A file holding the target data of analysis is specified as an input file in the input file specification box 21.

A file to which the results of data analysis are output is specified in an output file specification box 22. A csv file is specified in FIG. 3, but an XML file and other types of files can be specified.

A variable by which the record group stored in the specified input file is sorted is specified in the sort variable specification box 23. The sort variable is specified by a number in the variable specification field 24, which will be described next. If numbers “4” and “5” are specified, the record group is sorted by both time and “Res.” (resistance).

The variable specification field 24 is provided to specify variables the correlation between which is calculated, from the variables in the record group stored in the specified input file. The variable names are specified in variable name specification boxes 24a to 24n.

The shown example is a screen for analyzing the process data of semiconductor manufacturing. The channel length of a transistor formed in a chip, transistor voltage threshold (VT), current value (AMP), time at which the data is recorded, transistor resistance (Res.), and yield of a semiconductor device are specified in the variable name specification boxes 24a, 24b, 24c, 24d, 24e, and 24n respectively. Among the variables, the channel length, VT, and Yield are selected in the figure. A variable having a smaller number in the variable name specification box becomes variable x in the simple regression equation while a variable having a greater number becomes variable y.

The shown specification causes the values of the gradient a and the intercept b of the simple regression equation y=ax+b and the contribution R² to be calculated in three different combinations where x is the channel length and y is VT, where x is VT and y is Yield, and where x is the channel length and y is Yield. If n (n is a positive integer) variables are specified, the values of the gradient a and the intercept b of the simple regression equation y=ax+b and the contribution R² are calculated in ₙC₂ combinations.

A manner of dividing the target record group of data analysis is specified in the division specification field 25. A check button 26 is selected to divide the record group in such a manner that the subordinate record groups do not overlap (automatic division). A check button 27 is selected to divide the record group in such a manner that the subordinate record groups overlap (automatic division is not performed).

A division count specification box 28 is provided to specify a desired number of parts into which the target record group of data analysis is divided when the check button 26 is selected. An n-th power of 2 can be specified in the division count specification box 28. When the n-th power of 2 is specified in this box, the gradient a and the intercept b of the simple regression equation y=ax+b and the contribution R² are calculated for each of the 2ⁿ subordinate record groups. The gradient a and the intercept b of the simple regression equation y=ax+b and the contribution R² may be calculated even if the record group is divided to one part.

Boxes 29 and 30 can be used when the check button 27 is selected. These boxes are used to divide the target record group of data analysis into groups of a specified number of records at specified intervals. A desired number of records to be grouped is specified in the box 29, and a desired record interval is specified in the box 30.

The threshold specification box 31 is provided to specify a threshold of the contribution R² at which it is determined to output the information of the correlation (the gradient a and the intercept b of the simple regression equation y=ax+b and the contribution R²). A Run button 32 is clicked on to input the execution control data specified on the execution control data input screen and to start data analysis accordingly.

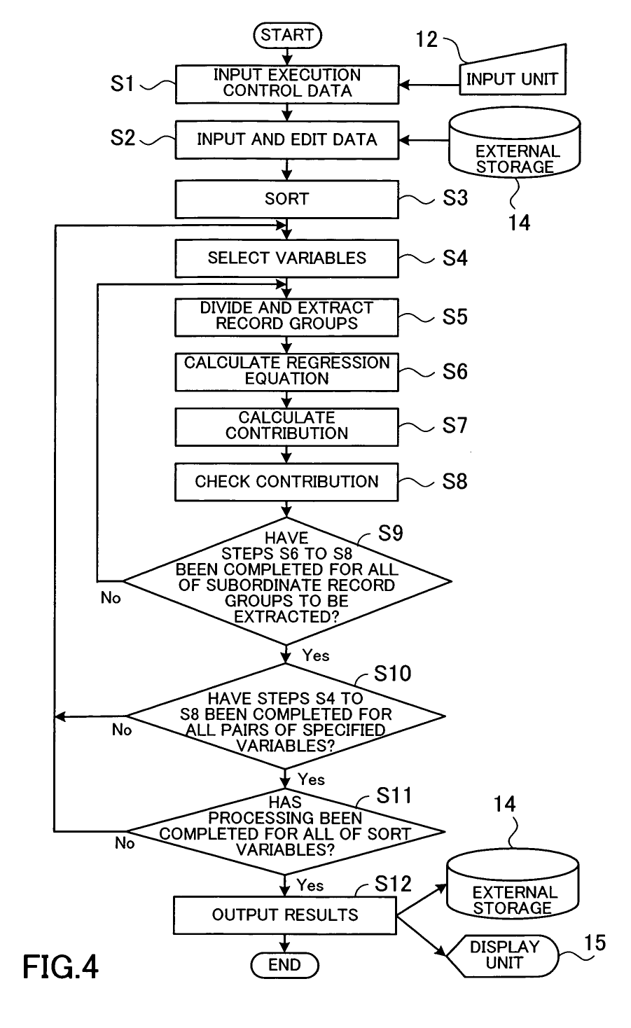

FIG. 4 is a flow chart showing the procedure of data analysis performed by the data analysis apparatus shown in FIG. 2. After execution control data is specified on the execution control data input screen shown in FIG. 3, the Run button 32 is clicked on to start data analysis. When the data analysis start instruction is given, the data analysis apparatus inputs the execution control data specified on the execution control data input screen (step S1). The execution control data input program 13a executed by the CPU 11 implements this step.

When the input of the execution control data is completed, the data analysis apparatus inputs data from the input file specified in the input file specification box 21 of the execution control data input screen shown in FIG. 3, and edits the data into a record group if the data has not yet been edited (step S2). The data input-and-edit program 13b executed by the CPU 11 implements this step.

The data analysis apparatus sorts the record group by a variable specified in the sort variable specification box 23 shown in FIG. 3 (step S3). If two or more variables are specified in the box, the record group is sorted by each of the variables. The sort program 13c executed by the CPU 11 implements this step.

The data analysis apparatus selects a pair of variables from the variables specified in the variable name specification boxes 24a to 24n of the execution control data input screen shown in FIG. 3 (step S4). The variable selection program 13d executed by the CPU 11 implements this step.

The data analysis apparatus divides the target record group of data analysis stored in the main memory 13 in the dividing manner specified in the division specification field 25 of the execution control data input screen shown in FIG. 3, and extracts a subordinate record group (step S5). The record group divide-and-extract program 13e executed by the CPU 11 implements this step.

The data analysis apparatus calculates the gradient a and the intercept b of the simple regression equation y=ax+b in the extracted subordinate record group (step S6). The regression equation calculation program 13f executed by the CPU 11 implements this step of regression equation calculation.

The data analysis apparatus calculates the contribution R² in the extracted subordinate record group (step S7). The contribution calculation program 13g executed by the CPU 11 implements this step of contribution calculation. The regression equation calculation and the contribution calculation form the correlation processing.

The data analysis apparatus compares the contribution R² obtained from the contribution calculation with the threshold of the contribution R² specified in the threshold specification box 31 of the execution control data input screen shown in FIG. 3, and checks whether the calculated contribution R² is greater than or equal to the threshold (step S8). The contribution judgment program 13h executed by the CPU 11 implements the contribution judgment step.

The data analysis apparatus checks whether steps S6 to S8 are completed for all of the subordinate record groups to be extracted (step S9). If not, the processing returns to step S5.

If steps S6 to S8 are completed for all of the subordinate record groups to be extracted, the data analysis apparatus checks whether steps S4 to S8 are completed for all pairs of the specified variables (step S10). If not, the processing returns to step S4.

The data analysis apparatus checks whether steps S4 to S8 are completed for all of the specified sort variables (step S11). If not, the processing returns to step S4.

If steps S4 to S8 are completed for all of the specified sort variables, the data analysis apparatus outputs the results of data analysis of only a pair of variables where the calculated contribution R² is greater than or equal to the threshold (step S12). The result output program 13i executed by the CPU 11 implements the result output step.

Some examples will be shown to explain that a correlation of data depends on the sorting of the record group according to a variable and the recording-group dividing manner. A sort variable can be specified in the sort variable specification box 23 of the execution control data input screen shown in FIG. 3. If variables 4 and 5 (time and resistance) are specified in the sort variable specification box 23, the results of data analysis of the record group sorted by time and the results of data analysis of the record group sorted by resistance can be obtained.

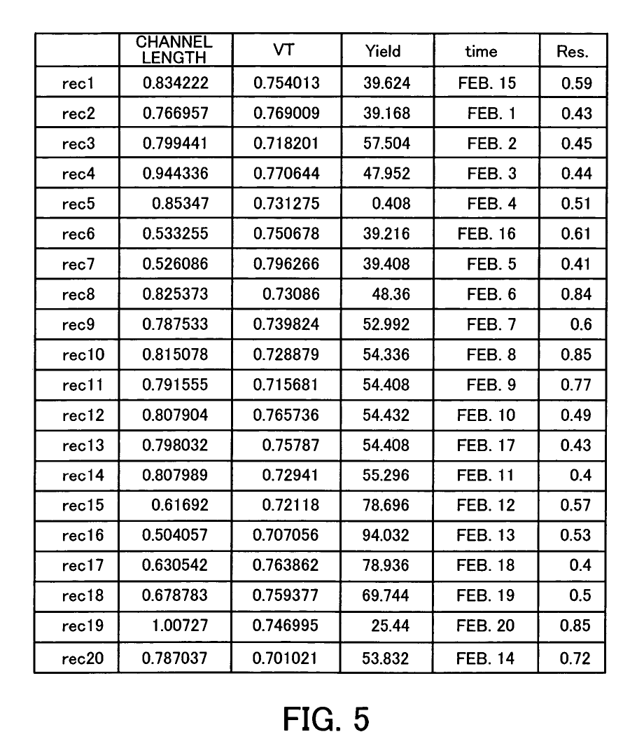

FIG. 5 shows a target record group of data analysis. The shown record group is example process data of semiconductor manufacturing, and contains twenty records rec1 to rec20. Each record includes transistor parameters: a channel length, a voltage threshold (VT), a yield, and a resistance (Res.). A data recording time (time) is also included (just the date is shown in the figure).

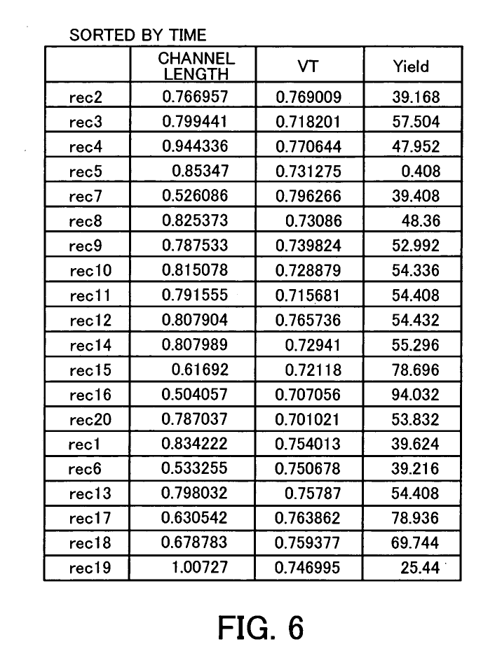

FIG. 6 shows a record group obtained by sorting the record group shown in FIG. 5 by time. The arrangement shown in FIG. 5 is rearranged as shown in FIG. 6 by sorting the record group by time. In FIG. 6, the resistance values and time values are omitted.

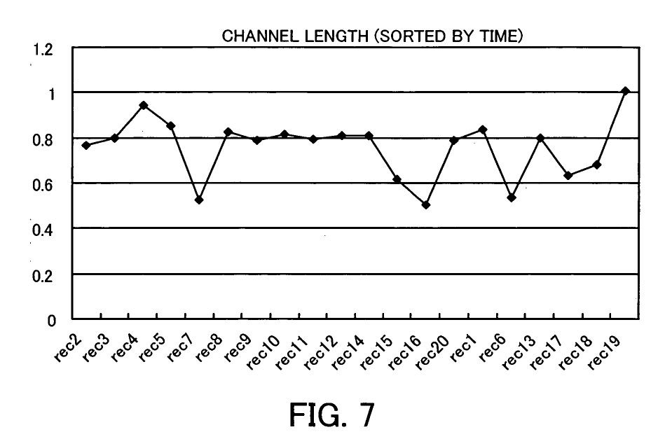

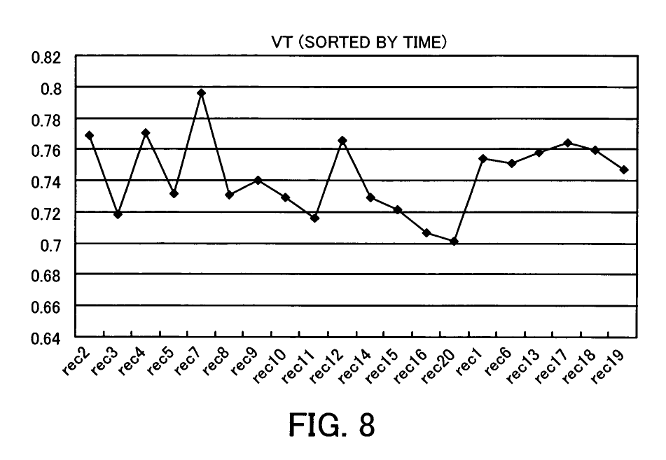

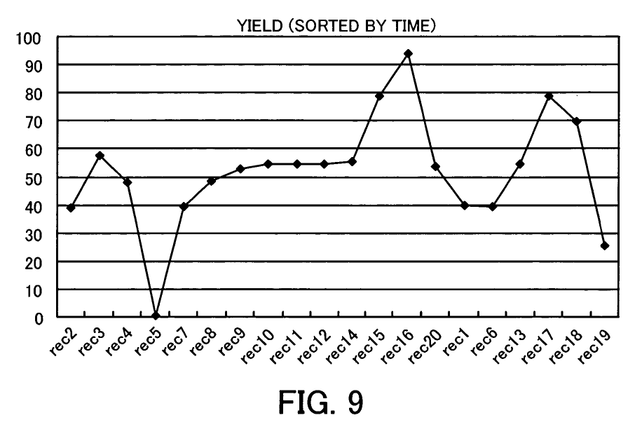

FIG. 7 shows the trend of the channel length in the record group shown in FIG. 6. FIG. 8 shows the trend of the threshold voltage in the record group shown in FIG. 6. FIG. 9 shows the trend of the yield in the record group shown in FIG. 6. FIGS. 7 to 9 show that it is hard to find a correlation between any two variables in the record group shown in FIG. 6.

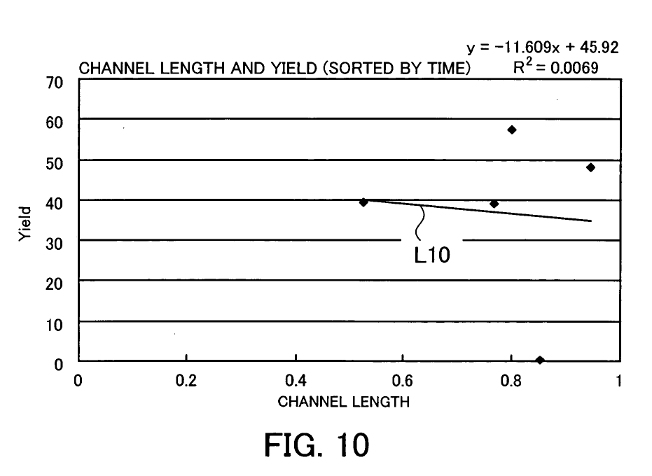

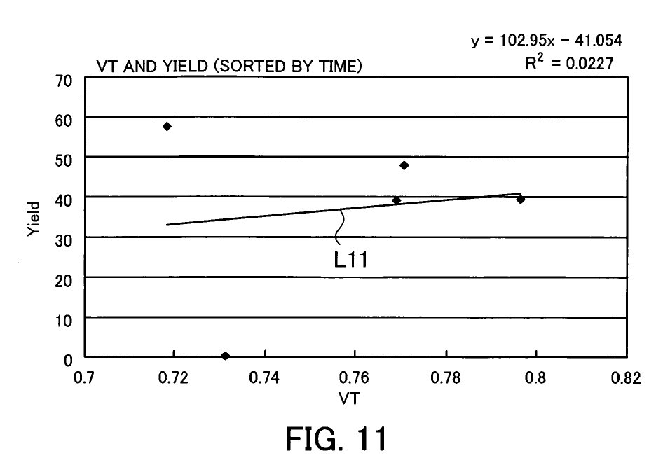

FIG. 10 is a first chart showing the correlation between the channel length and the yield in the sorted record group shown in FIG. 6. The figure shows the correlation between the channel length and the yield of the first to fifth records (rec2, rec3, rec4, rec5, and rec7) shown in FIG. 6. Line L10 shown in FIG. 10 represents a simple regression equation, and the contribution R² in the figure is 0.0069. FIG. 11 is a first chart showing the correlation between the threshold and the yield in the sorted record group shown in FIG. 6. The figure shows the correlation between the threshold and the yield of the first to fifth records shown in FIG. 6. Line L11 shown in FIG. 11 represents a simple regression equation, and the contribution R² in the figure is 0.0227.

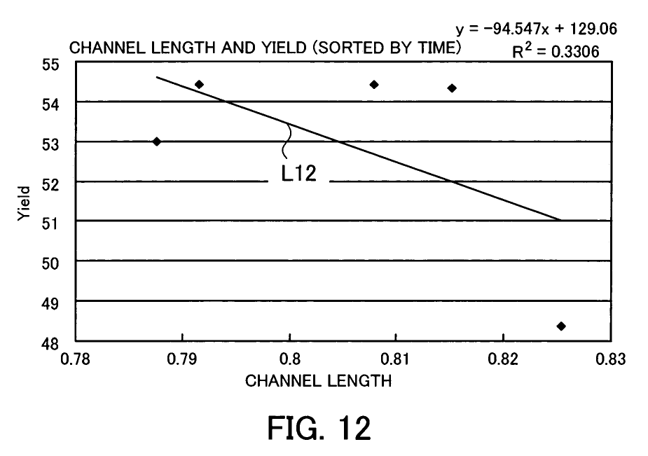

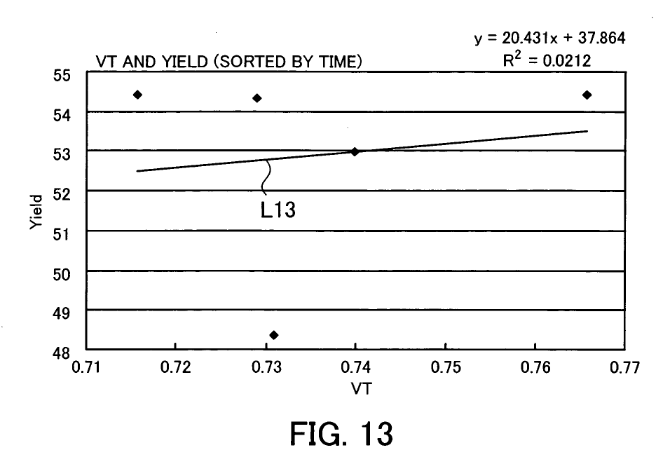

FIG. 12 is a second chart showing the correlation between the channel length and the yield in the sorted record group shown in FIG. 6. The figure shows the correlation between the channel length and the yield of the sixth to tenth records (rec8, rec9, rec10, rec11, and rec12) shown in FIG. 6. Line L12 shown in FIG. 12 represents a simple regression equation, and the contribution R² in the figure is 0.3306. FIG. 13 is a second chart showing the correlation between the threshold and the yield in the sorted record group shown in FIG. 6. The figure shows the correlation between the threshold and the yield of the sixth to tenth records shown in FIG. 6. Line L13 shown in FIG. 13 represents a simple regression equation, and the contribution R² in the figure is 0.0212.

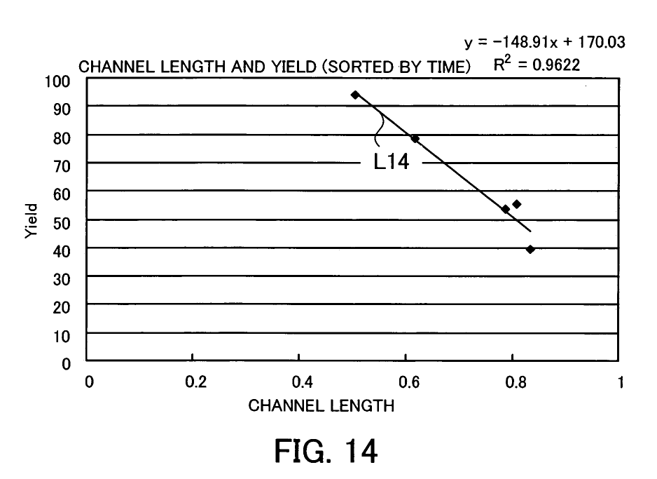

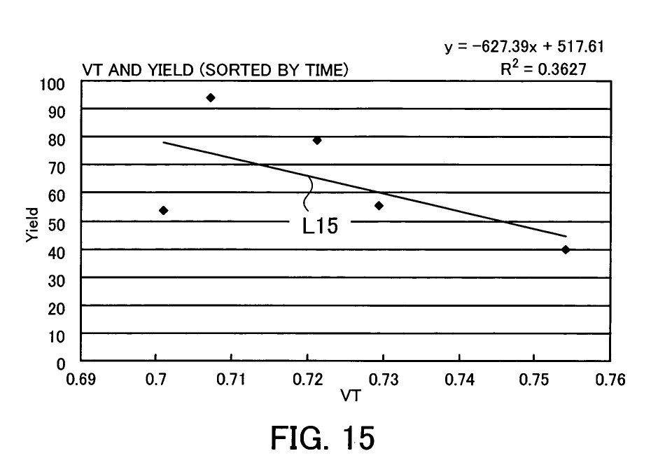

FIG. 14 is a third chart showing the correlation between the channel length and the yield in the sorted record group shown in FIG. 6. The figure shows the correlation between the channel length and the yield of the eleventh to fifteenth records (rec14, rec15, rec16, rec20, and rec1) shown in FIG. 6. Line L14 shown in FIG. 14 represents a simple regression equation, and the contribution R² in the figure is 0.9622. FIG. 15 is a third chart showing the correlation between the threshold and the yield in the sorted record group shown in FIG. 6. The figure shows the correlation between the threshold and the yield of the eleventh to fifteenth records shown in FIG. 6. Line L15 shown in FIG. 15 represents a simple regression equation, and the contribution R² in the figure is 0.3627.

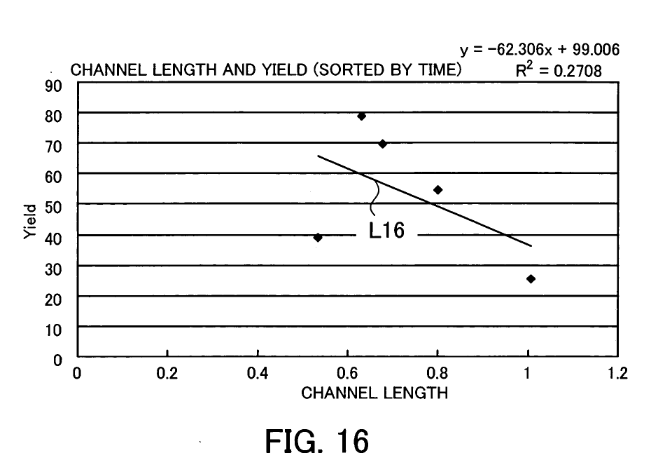

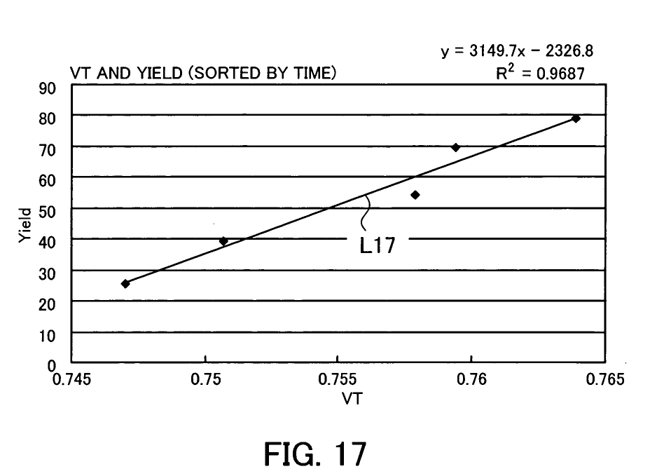

FIG. 16 is a fourth chart showing the correlation between the channel length and the yield in the sorted record group shown in FIG. 6. The figure shows the correlation between the channel length and the yield of the sixteenth to twentieth records (rec6, rec13, rec17, rec18, and rec19) shown in FIG. 6. Line L16 shown in FIG. 16 represents a simple regression equation, and the contribution R² in the figure is 0.2708. FIG. 17 is a fourth chart showing the correlation between the threshold and the yield in the sorted record group shown in FIG. 6. The figure shows the correlation between the threshold and the yield of the sixteenth to twentieth records shown in FIG. 6. Line L17 shown in FIG. 17 represents a simple regression equation, and the contribution R² in the figure is 0.9687.

FIGS. 10 to 17 show that the eleventh to fifteenth records have a strong correlation between the channel length and the yield (FIG. 14), and that the sixteenth to twentieth records have a strong correlation between the threshold and the yield (FIG. 17). Although a weak correlation is found through the analysis of all the data listed in FIG. 5, strong correlations as shown in FIGS. 14 and 17 can be found by sorting and dividing the record group according to time.

Further examples will be taken to explain a correlation that can be found by changing the way of dividing the data.

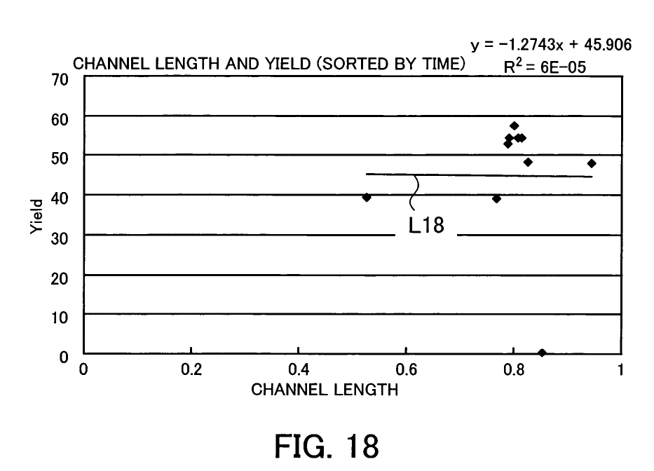

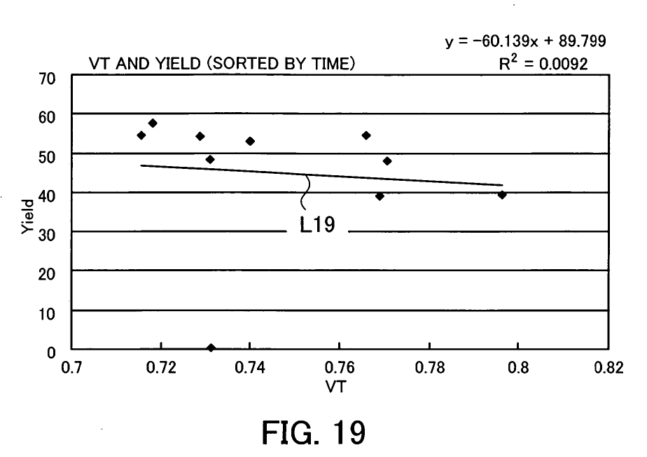

FIG. 18 is a fifth chart showing the correlation between the channel length and the yield in the sorted record group shown in FIG. 6. The figure shows the correlation between the channel length and the yield of the first to tenth records (rec2, rec3, rec4, rec5, rec7, rec8, rec9, rec10, rec11, rec12) shown in FIG. 6. Line L18 shown in FIG. 18 represents a simple regression equation, and the contribution R² in the figure is 6E-05. FIG. 19 is a fifth chart showing the correlation between the threshold and the yield in the sorted record group shown in FIG. 6. The figure shows the correlation between the threshold and the yield of the first to tenth records shown in FIG. 6. Line L19 shown in FIG. 19 represents a simple regression equation, and the contribution R² in the figure is 0.0092.

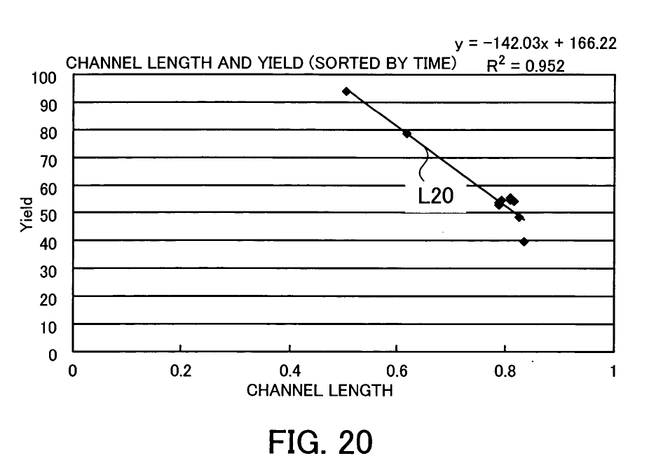

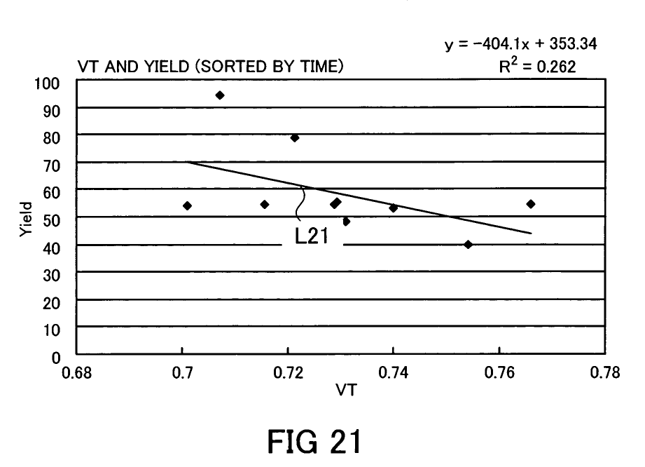

FIG. 20 is a sixth chart showing the correlation between the channel length and the yield in the sorted record group shown in FIG. 6. The figure shows the correlation between the channel length and the yield of the sixth to fifteenth records (rec8, rec9, rec10, rec11, rec12, rec14, rec15, rec16, rec20, and rec1) shown in FIG. 6. Line L20 shown in FIG. 20 represents a simple regression equation, and the contribution R² in the figure is 0.952. FIG. 21 is a sixth chart showing the correlation between the threshold and the yield in the sorted record group shown in FIG. 6. The figure shows the correlation between the threshold and the yield of the sixth to fifteenth records shown in FIG. 6. Line L21 shown in FIG. 21 represents a simple regression equation, and the contribution R² in the figure is 0.262.

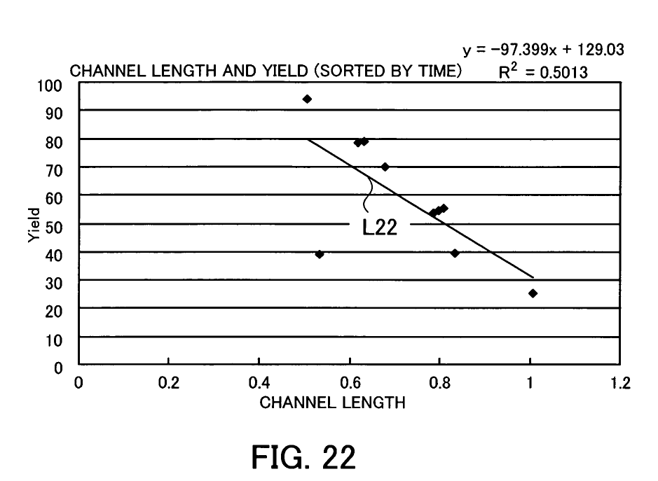

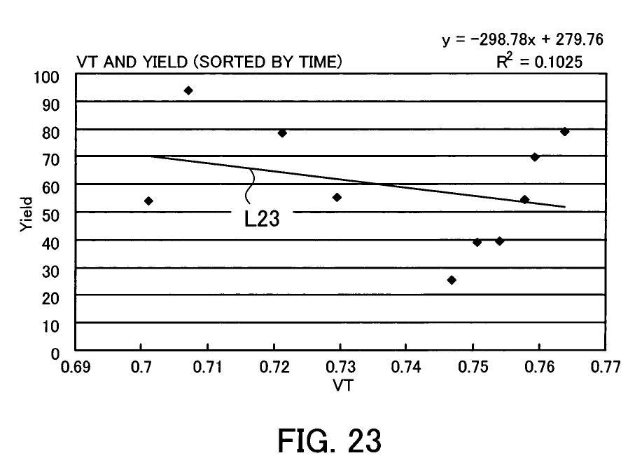

FIG. 22 is a seventh chart showing the correlation between the channel length and the yield in the sorted record group shown in FIG. 6. The figure shows the correlation between the channel length and the yield of the eleventh to twentieth records (rec14, rec15, rec16, rec20, rec1, rec6, rec13, rec17, rec18, rec19) shown in FIG. 6. Line L22 shown in FIG. 22 represents a simple regression equation, and the contribution R² in the figure is 0.5013. FIG. 23 is a seventh chart showing the correlation between the threshold and the yield in the sorted record group shown in FIG. 6. The figure shows the correlation between the threshold and the yield of the eleventh to twentieth records shown in FIG. 6. Line L23 shown in FIG. 23 represents a simple regression equation, and the contribution R² in the figure is 0.1025.

FIGS. 18 to 23 show that the sixth to fifteenth records have a strong correlation between the channel length and the yield (FIG. 20), and that the records do not have a strong correlation between the threshold and the yield. Although a weak correlation is found from the analysis of all the data shown in FIG. 5, a correlation as shown in FIG. 20 can be found by sorting and dividing the record group according to a variable.

Additional examples will be used to explain a correlation found when the record group shown in FIG. 5 is sorted and divided according to the resistance value.

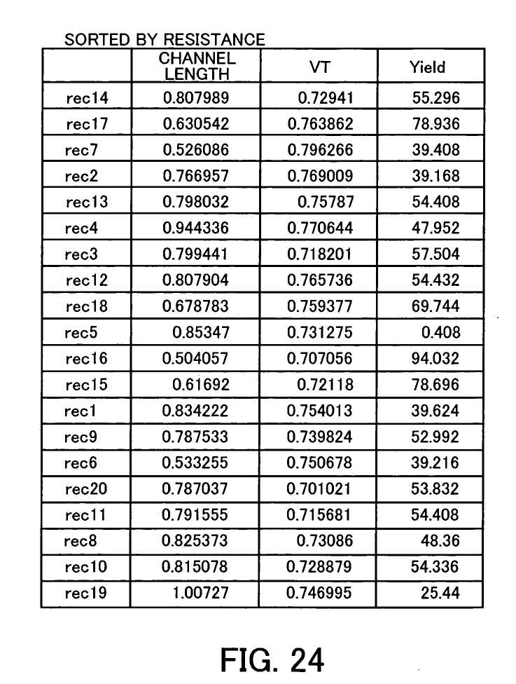

FIG. 24 shows a record group obtained by sorting the record group shown in FIG. 5 by the resistance value. The arrangement shown in FIG. 5 is rearranged as shown in FIG. 24 by sorting the record group by the resistance value. In FIG. 24, the resistance values and time values are omitted.

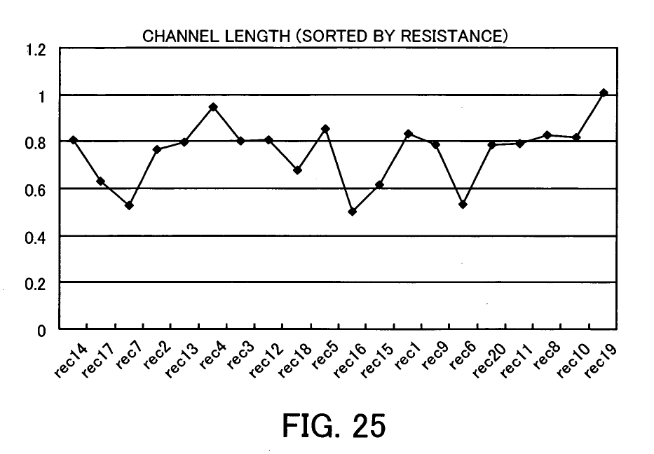

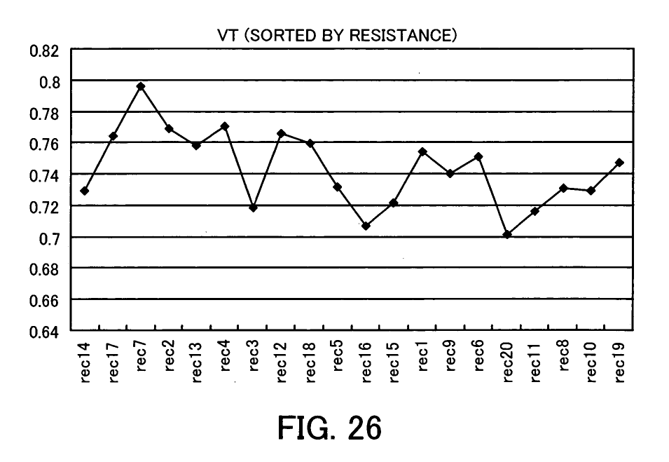

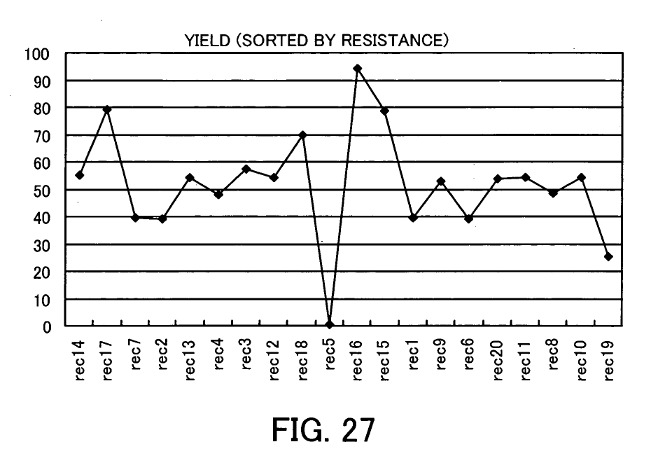

FIG. 25 shows the trend of the channel length in the record group shown in FIG. 24. FIG. 26 shows the trend of the threshold voltage in the record group shown in FIG. 24. FIG. 27 shows the trend of the yield in the record group shown in FIG. 24. FIGS. 25 to 27 show that it is hard to find a correlation between any two variables in the record group shown in FIG. 24.

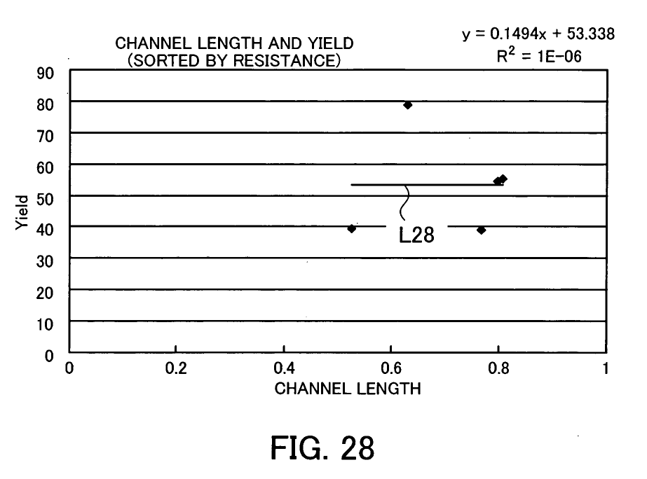

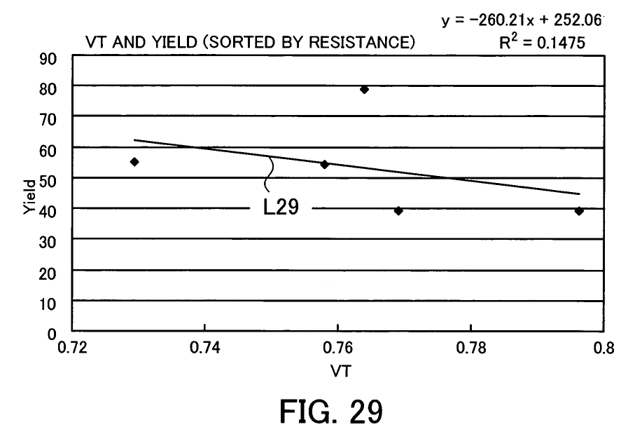

FIG. 28 is a first chart showing the correlation between the channel length and the yield in the sorted record group shown in FIG. 24. The figure shows the correlation between the channel length and the yield of the first to fifth records (rec14, rec17, rec7, rec2, and rec13) shown in FIG. 24. Line L28 shown in FIG. 28 represents a simple regression equation, and the contribution R² in the figure is 1E-06. FIG. 29 is a first chart showing the correlation between the threshold and the yield in the sorted record group shown in FIG. 24. The figure shows the correlation between the threshold and the yield of the first to fifth records shown in FIG. 24. Line L29 shown in FIG. 29 represents a simple regression equation, and the contribution R² in the figure is 0.1475.

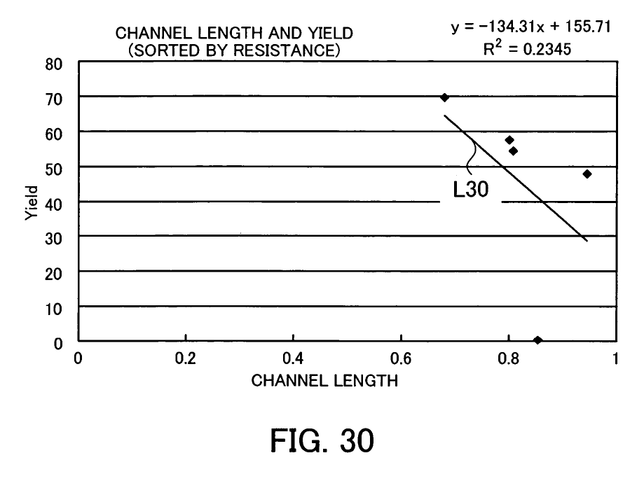

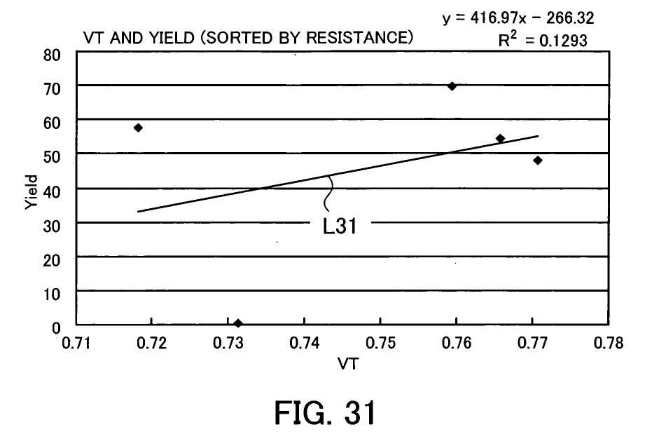

FIG. 30 is a second chart showing the correlation between the channel length and the yield in the sorted record group shown in FIG. 24. The figure shows the correlation between the channel length and the yield of the sixth to tenth records (rec4, rec3, rec12, rec18, and rec5) shown in FIG. 24. Line L30 shown in FIG. 30 represents a simple regression equation, and the contribution R² in the figure is 0.2345. FIG. 31 is a second chart showing the correlation between the threshold and the yield in the sorted record group shown in FIG. 24. The figure shows the correlation between the threshold and the yield of the sixth to tenth records shown in FIG. 24. Line L31 shown in FIG. 31 represents a simple regression equation, and the contribution R² in the figure is 0.1293.

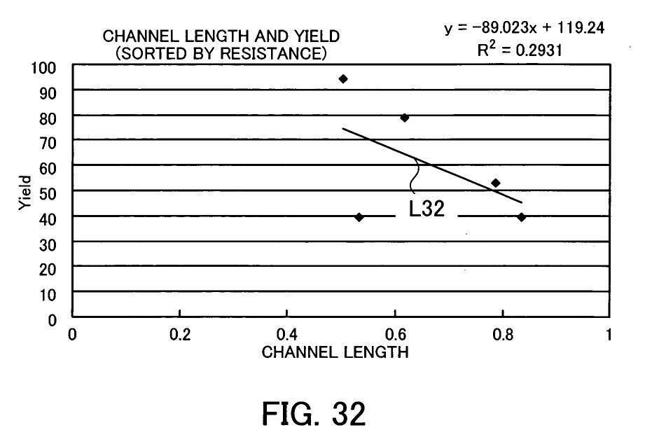

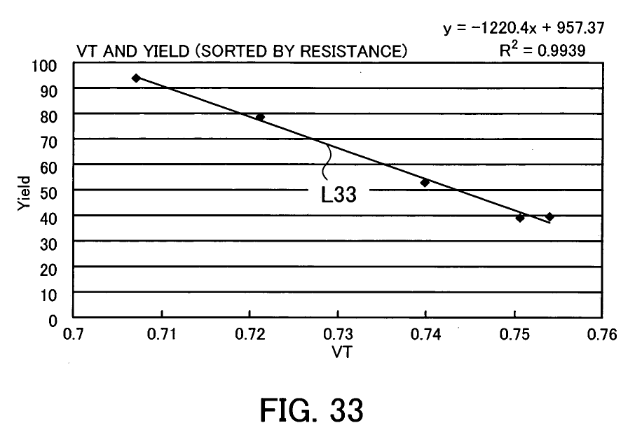

FIG. 32 is a third chart showing the correlation between the channel length and the yield in the sorted record group shown in FIG. 24. The figure shows the correlation between the channel length and the yield of the eleventh to fifteenth records (rec16, rec15, rec1, rec9, and rec6) shown in FIG. 24. Line L32 shown in FIG. 32 represents a simple regression equation, and the contribution R² in the figure is 0.2931. FIG. 33 is a third chart showing the correlation between the threshold and the yield in the sorted record group shown in FIG. 24. The figure shows the correlation between the threshold and the yield of the eleventh to fifteenth records shown in FIG. 24. Line L33 shown in FIG. 33 represents a simple regression equation, and the contribution R² in the figure is 0.9939.

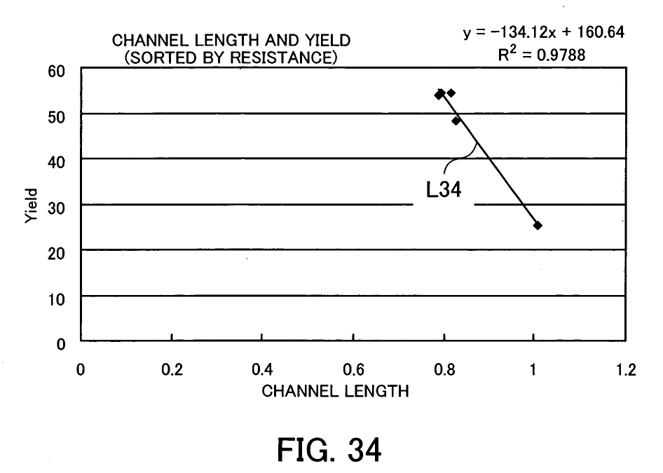

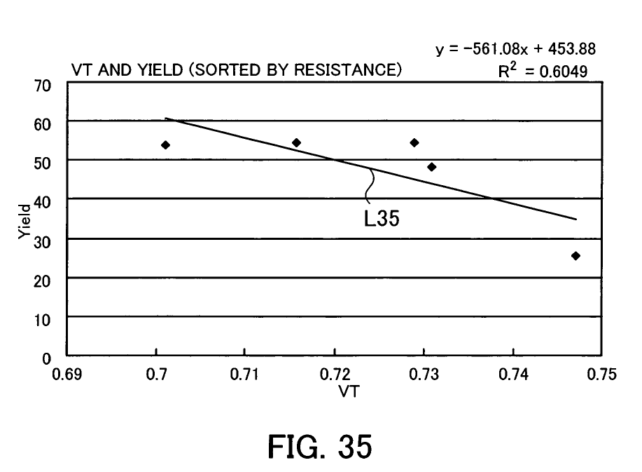

FIG. 34 is a fourth chart showing the correlation between the channel length and the yield in the sorted record group shown in FIG. 24. The figure shows the correlation between the channel length and the yield of the sixteenth to twentieth records (rec20, rec11, rec8, rec10, and rec19) shown in FIG. 24. Line L34 shown in FIG. 34 represents a simple regression equation, and the contribution R² in the figure is 0.9788. FIG. 35 is a fourth chart showing the correlation between the threshold and the yield in the record group shown in FIG. 24. The figure shows the correlation between the threshold and the yield of the sixteenth to twentieth records shown in FIG. 24. Line L35 shown in FIG. 35 represents a simple regression equation, and the contribution R² in the figure is 0.6049.

FIGS. 28 to 35 show that the sixteenth to twentieth records have a strong correlation between the channel length and the yield (FIG. 34) and that the eleventh to fifteenth records have a strong correlation between the threshold and the yield (FIG. 33). Although a weak correlation is found through the analysis of all the data listed in FIG. 5, strong correlations as shown in FIGS. 33 and 34 can be found by sorting and dividing the record group according to the resistance value.

Further examples will be used to explain that a different correlation can be found by changing the way of dividing the record group sorted by the resistance value.

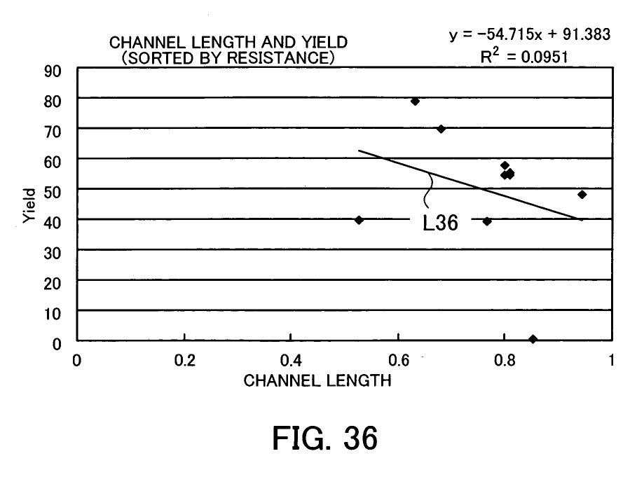

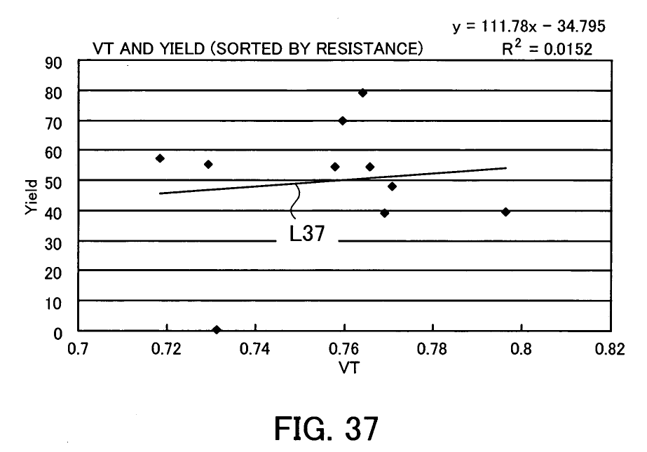

FIG. 36 is a fifth chart showing the correlation between the channel length and the yield in the sorted record group shown in FIG. 24. The figure shows the correlation between the channel length and the yield of the first to tenth records (rec14, rec17, rec7, rec2, rec13, rec4, rec3, rec12, rec18, and rec5) shown in FIG. 24. Line L36 shown in FIG. 36 represents a simple regression equation, and the contribution R² in the figure is 0.0951. FIG. 37 is a fifth chart showing the correlation between the threshold and the yield in the sorted record group shown in FIG. 24. The figure shows the correlation between the threshold and the yield of the first to tenth records shown in FIG. 24. Line L37 shown in FIG. 37 represents a simple regression equation, and the contribution R² in the figure is 0.0152.

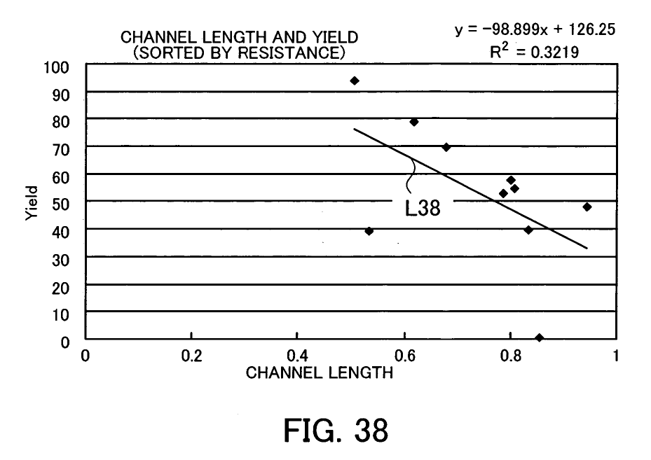

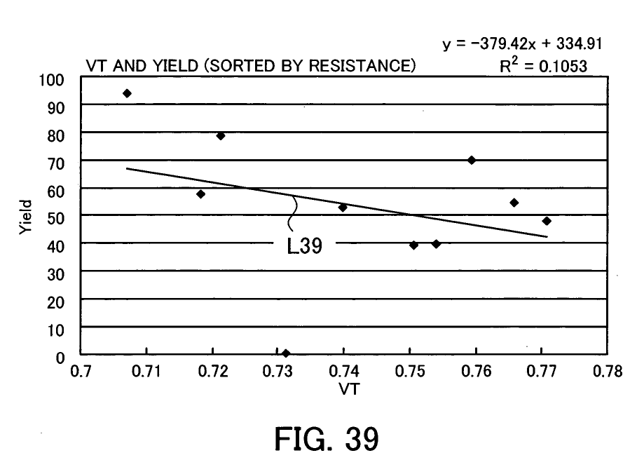

FIG. 38 is a sixth chart showing the correlation between the channel length and the yield in the sorted record group shown in FIG. 24. The figure shows the correlation between the channel length and the yield of the sixth to fifteenth records (rec4, rec3, rec12, rec18, rec5, rec16, rec15, rec1, rec9, and rec6) shown in FIG. 24. Line L38 shown in FIG. 38 represents a simple regression equation, and the contribution R² in the figure is 0.3219. FIG. 39 is a sixth chart showing the correlation between the threshold and the yield in the sorted record group shown in FIG. 24. The figure shows the correlation between the threshold and the yield of the sixth to fifteenth records shown in FIG. 24. Line L39 shown in FIG. 39 represents a simple regression equation, and the contribution R² in the figure is 0.1053.

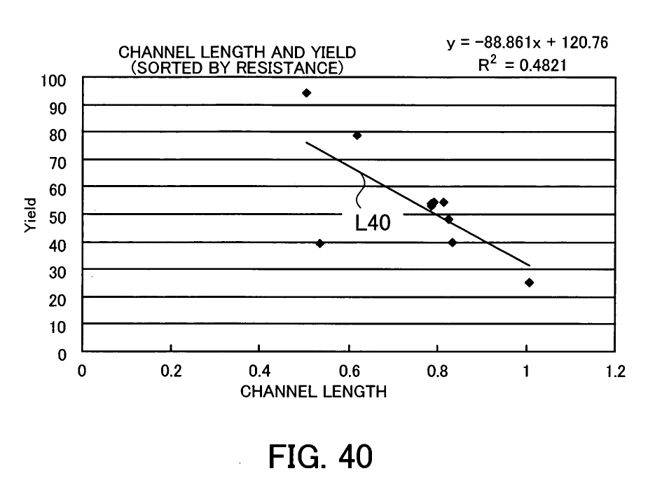

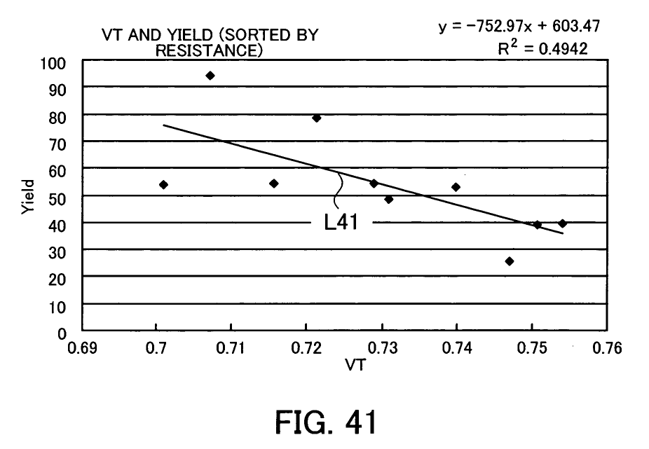

FIG. 40 is a seventh chart showing the correlation between the channel length and the yield in the sorted record group shown in FIG. 24. The figure shows the correlation between the channel length and the yield of the eleventh to twentieth records (rec16, rec15, rec1, rec9, rec6, rec20, rec11, rec8, rec10, and rec19) shown in FIG. 24. Line L40 shown in FIG. 40 represents a simple regression equation, and the contribution R² in the figure is 0.4821. FIG. 41 is a seventh chart showing the correlation between the threshold and the yield in the sorted record group shown in FIG. 24. The figure shows the correlation between the threshold and the yield of the eleventh to twentieth records shown in FIG. 24. Line L41 shown in FIG. 41 represents a simple regression equation, and the contribution R² in the figure is 0.4942.

FIGS. 36 to 41 show that the record group does not have a strong correlation between the channel length and the yield or between the threshold and the yield.

Examples of the division of a record group will be described next.

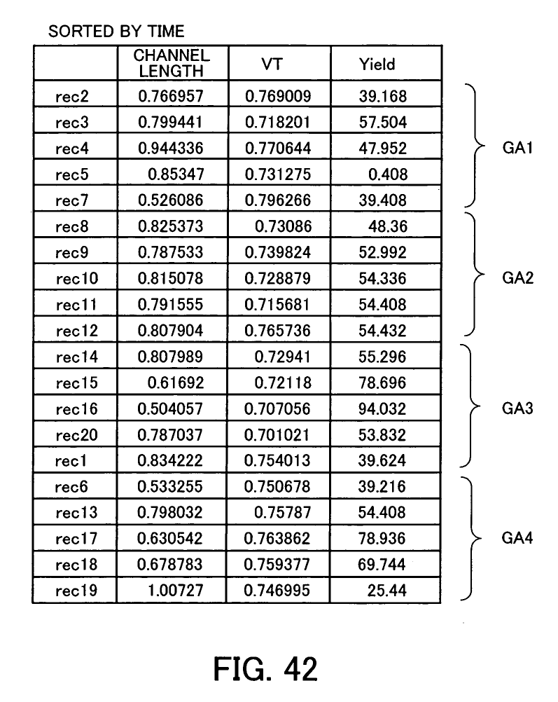

When automatic division is selected, the record group is divided as shown in FIG. 42. The figure shows an example of dividing the record group shown in FIG. 6 into four parts (when 4 is specified in the division count specification box 28 of the execution control data input screen shown in FIG. 3). The records rec2 to rec19 are divided into a subordinate record group GA1 of records rec2 to rec7, a subordinate record group GA2 of records rec8 to rec12, a subordinate record group GA3 of records rec14 to rec1, and a subordinate record group GA4 of records rec6 to rec19.

The record group may also be divided in several ways, from the parts of 2 to the zeroth power up to the parts of 2 to the n-th power, specified in the division count specification box 28. If the value specified in the division count specification box 28 is 16 (2⁴), the record group may be divided into one (2⁰) part, two (2¹) parts, four (2²) parts, eight (2³) parts, and sixteen (2⁴) parts. This processing is performed by the record group divide-and-extract program 13e described with reference to FIG. 2.

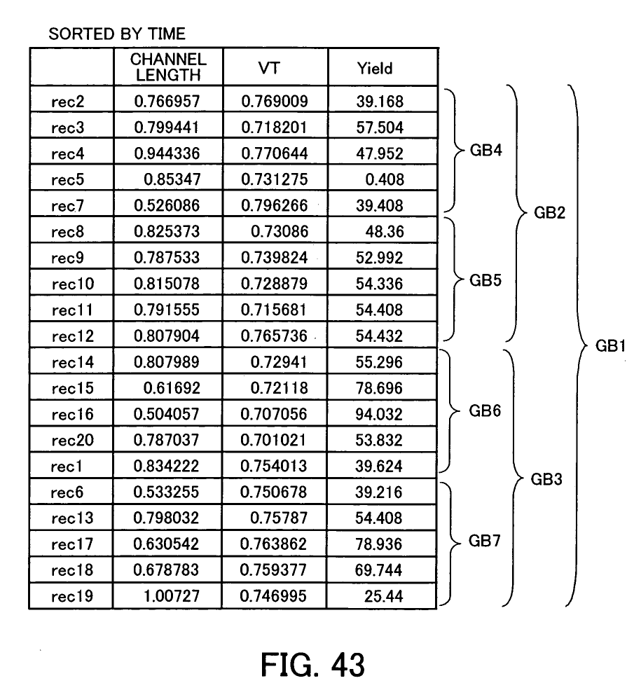

FIG. 43 shows an example of dividing the record group into 2⁰ parts, 2¹ parts, and 2² parts when 4 is specified in the division count specification box 28. A subordinate record group GB1 includes records rec2 to rec19; a subordinate record group GB2 includes records rec2 to rec12; a subordinate record group GB3 includes records rec14 to rec19; a subordinate record group GB4 includes records rec2 to rec7; a subordinate record group GB5 includes records rec8 to rec12; a subordinate record group GB6 includes records rec14 to rec1; and a subordinate record group GB7 includes records rec6 to rec19.

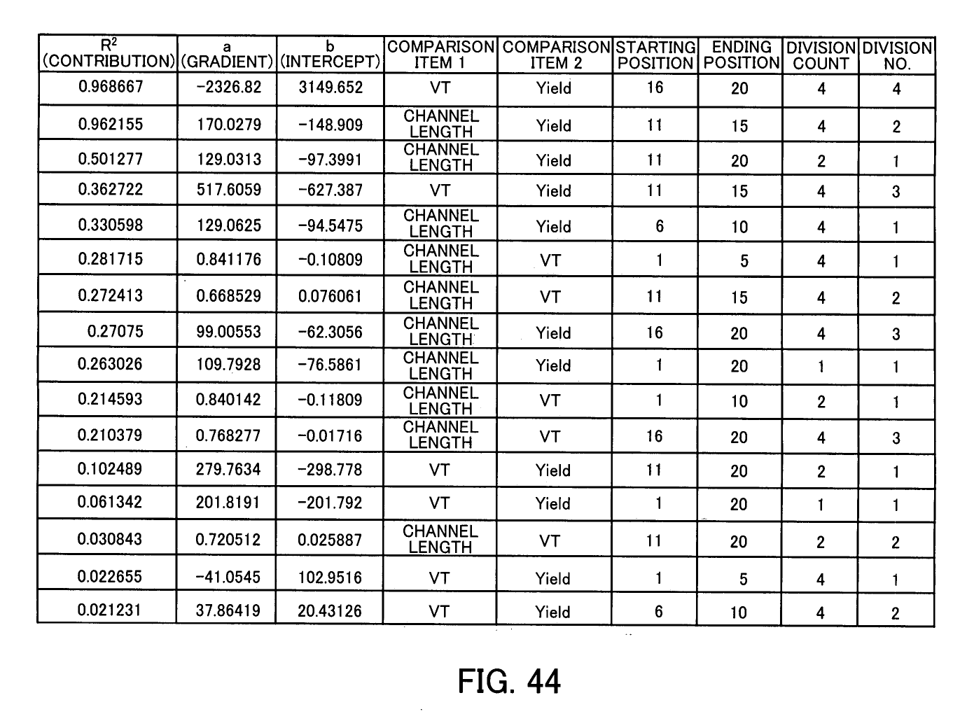

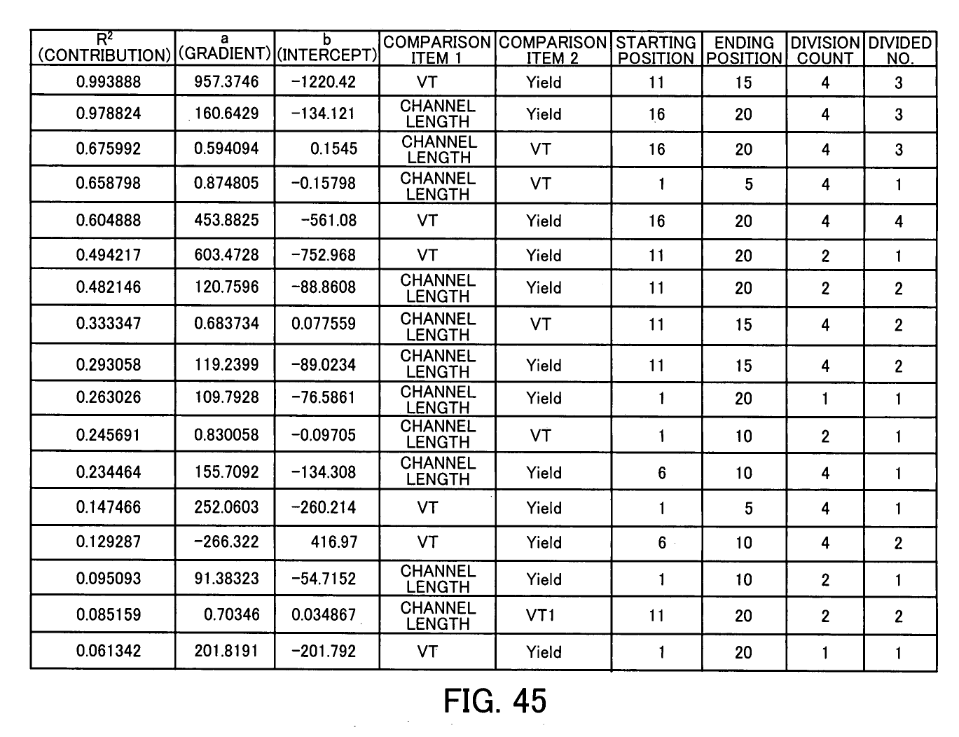

FIG. 44 shows the results of analysis of the record group divided as shown in FIG. 43. The record group has been sorted by time and resistance and has been divided by specifying a division count of four and automatic division. The channel length, the threshold voltage, and the yield have been selected as variables to be compared. Both the results of analysis after sorting by time and the results of analysis after sorting by resistance are output. FIG. 44 shows the former analysis results, and FIG. 45 shows the latter analysis results.

The output values obtained after the analysis are the contribution R², which is a quantitative evaluation value of the correlation, the gradient a and the intercept b of the simple regression equation y=ax+b, comparison items (variables) 1 and 2, the starting position and the ending position of the subordinate record group (the number of the starting record and the number of the ending record), the division count, and the division number.

FIG. 45 shows the results of analysis of the record group sorted by resistance shown in FIG. 24 and divided as shown in FIG. 43. As shown in FIGS. 44 and 45, a correlation between variables can be efficiently found by sorting and dividing a record group according to variables.

If automatic division is not selected, that is, if the check button 27 is selected on the execution control data input screen shown in FIG. 3, the record group will be analyzed as described below.

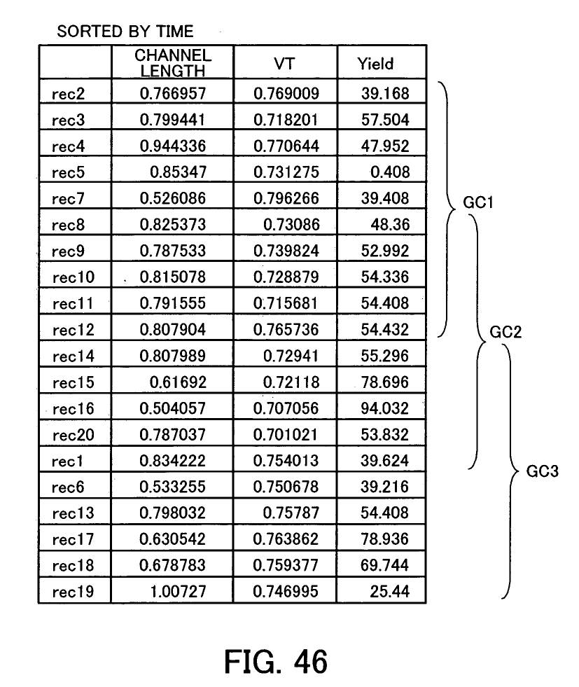

FIG. 46 shows an example of division when automatic division is not selected but the check button 27 is selected to divide the record group into groups of ten records at intervals of five records (by specifying 10 in the box 29 and 5 in the box 30) on the execution control data input screen shown in FIG. 3. The record group of records rec2 to rec19 is divided into a subordinate record group GC1 of records rec2 to rec12, a subordinate record group GC2 of records rec8 to rec1, and a subordinate record group GC3 of records rec14 to rec19.

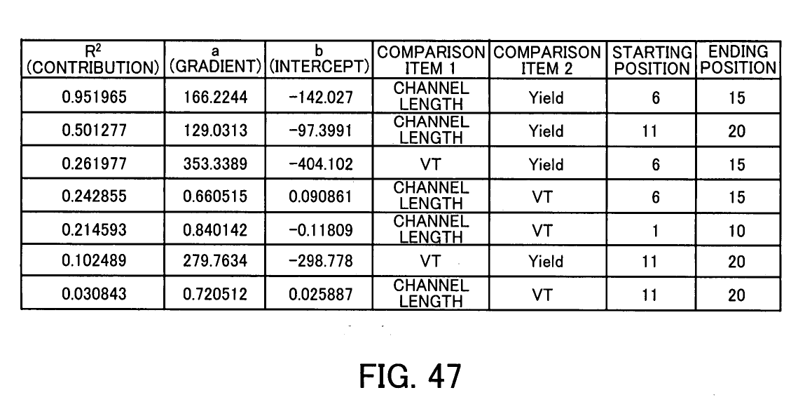

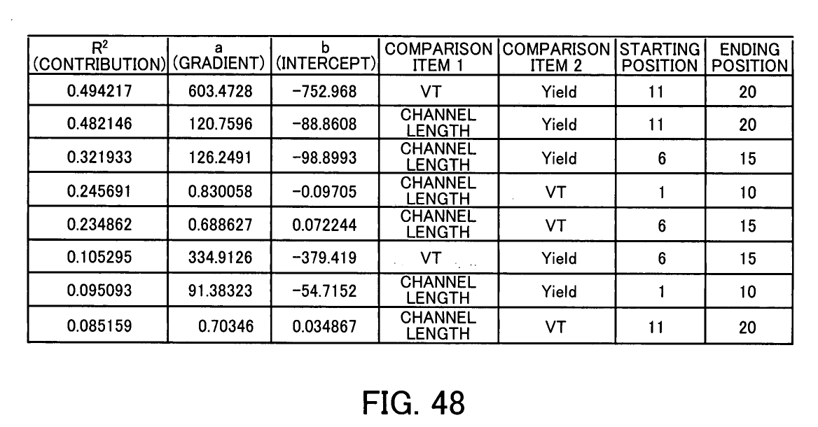

FIG. 47 shows the results of analysis of the records sorted and divided according to time as shown in FIG. 46. The record group is divided into ten-record groups at intervals of five records, and the results of analysis of the selected variables of the channel length, the threshold voltage, and the yield are shown in FIG. 47. FIG. 48 shows the results of the same analysis of the same record group after sorting by the resistance value.

The output values obtained after the analysis are the contribution R², which is a quantitative evaluation value of the correlation, the gradient a and the intercept b of the simple regression equation y=ax+b, comparison items (variables) 1 and 2, and the starting position and the ending position of the subordinate record group (the number of the starting record and the number of the ending record).

FIG. 48 shows the results of analysis of the record group sorted by resistance shown in FIG. 24 and divided as shown in FIG. 46. As shown in FIGS. 47 and 48, a correlation between variables can be efficiently extracted by sorting and dividing a record group according to variables.

The results of analysis obtained after the record group is not sorted will be described.

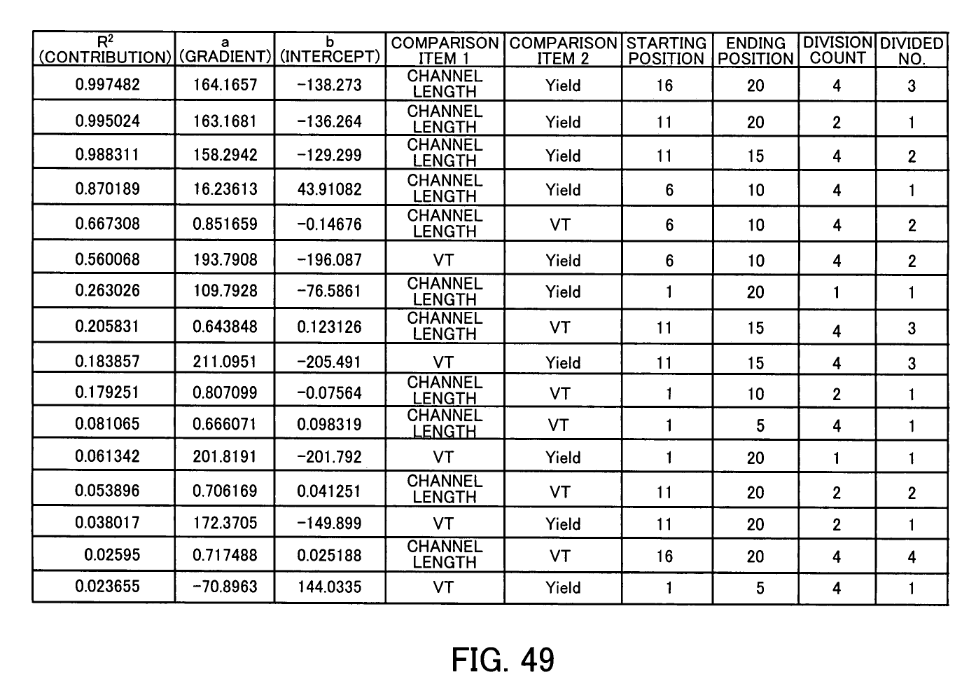

FIG. 49 is a first table listing the results of analysis of the record group shown in FIG. 5 when the record group is not sorted but divided as shown in FIG. 43.

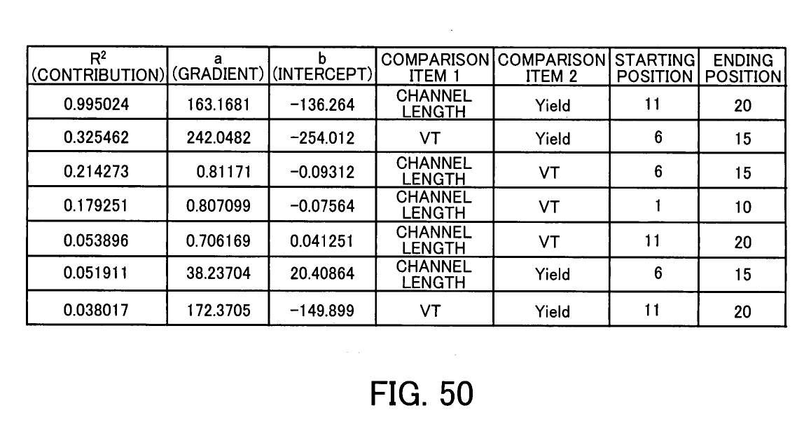

FIG. 50 is a second table listing the results of analysis of the record group shown in FIG. 5 when the record group is not sorted but divided as shown in FIG. 46.

FIGS. 49 and 50 show that the records rec11 to rec20 have a very strong correlation having a contribution R² of 0.99 between the channel length and the yield. The correlation between the threshold and the yield is not strong, and the maximum contribution R² is around 0.56.

In FIGS. 44 and 47, which show the results of analysis of the record group shown in FIG. 5 after the record group is sorted by time, a very strong correlation is found between the threshold and the yield. The contribution R² of the correlation among the records rec6, rec13, rec17, rec18, and rec19 is higher than 0.96 although such a strong correlation is not found in FIGS. 49 and 50. It is inferred that the strong correlation is found because the conditions have been unchanged around a certain time and that the strong correlation is hidden because the collected records are not always stored in the order of occurrence. FIGS. 44 and 47 also show a strong correlation between the channel length and the yield, as in FIGS. 49 and 50.

In FIGS. 45 and 48, which show the results of analysis of the record group shown in FIG. 5 after the record group is sorted by resistance, the strong correlation is found between the threshold and the yield. The contribution R² of the correlation among the records rec16, rec15, rec1, rec9, and rec6 is higher than 0.99 although such a strong correlation is not found in FIGS. 49 and 50. The contribution R² of the correlation between the channel length and the yield is higher than 0.97 among records rec20, rec11, rec8, rec10, and rec19. It is inferred that the correlation is hidden because either or both of the relevant variables become unstable under the influence of another variable. If the relationship between the variables varies, the correlation obtained by analyzing all the records will include much noise. A strong correlation is found between the channel length and the yield as well.

After the record group is sorted and divided, a strong correlation can be newly found for two reasons. The first reason is that sorting causes records including an exceptional value to gather in subordinate groups near the first or the last group, forming a record group including no exceptional value. The second reason is that the sorting of a record group by a variable increases the chance of bringing records of identical conditions into identical subordinate groups, consequently increasing the chance of finding a strong intrinsic correlation.

The data analysis apparatus is used to analyze manufacturing process data including a manufacturing apparatus log. In this industry, high volumes of diverse data are collected and analyzed in many systems for a very long time. If the wide range of discontiguous data is grouped just as they are in a file, few correlations can be found. After the record group is sorted and divided according to variables, many correlations can be found.

The processing described above can be implemented by a computer, and a program describing the processing is provided. The processing is implemented on a computer when the program is executed on the computer. The program describing the processing can be recorded on a computer-readable recording medium. Computer-readable recording media include magnetic recording apparatuses, optical discs, magneto-optical recording media, and semiconductor memory. Magnetic recording apparatuses include a hard disk drive (HDD), a flexible disk (FD), and a magnetic tape. Optical discs include a digital versatile disc (DVD), a digital versatile disc random access memory (DVD-RAM), a compact disc read only memory (CD-ROM), a compact disc recordable (CD-R), and a compact disc rewritable (CD-RW). Magneto-optical recording media include a magneto-optical disk (MO).

The program is distributed in the form of a transportable recording medium storing the program, such as a DVD or a CD-ROM. The program can also be stored in a recording apparatus of a sever computer and can be transferred from the server computer to another computer via a network.

The data analysis method of the present invention sorts a target record group by a specified variable and forms subordinate record groups in a specified dividing manner. A correlation between specified variables is calculated in each of the subordinate record groups. Accordingly, a correlation between variables can be efficiently extracted from the record group.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A data analysis method for extracting a correlation among data, the data analysis method comprising:
a record group sort step of sorting a target record group by a specified variable;
a record group divide-and-extract step of dividing the sorted target record group in a specified dividing manner and extracting subordinate record groups; and
a correlation calculation step of calculating a correlation between specified variables in each of the subordinate record groups.

2. The data analysis method according to claim 1, further comprising an execution control data input step of entering execution control data needed for data analysis.

3. The data analysis method according to claim 2, further comprising a data input step of entering data including the target record group from a predetermined storage unit in the case of the data including the target record group is specified as one of the execution control data.

4. The data analysis method according to claim 2, wherein the variable is included in the execution control data.

5. The data analysis method according to claim 2, wherein the dividing manner is included in the execution control data.

6. The data analysis method according to claim 5, wherein the dividing manner specifies the number of parts into which the target record group is divided.

7. The data analysis method according to claim 5, wherein the dividing manner specifies the number of records to be included in a subordinate record group and the number of records at which intervals the subordinate record groups are extracted.

8. The data analysis method according to claim 5, wherein the dividing manner specifies 2ⁿ, where n is a positive integer, as the maximum number of parts into which the target record group is divided, and the record group divide-and-extract step extracts subordinate record groups by dividing the target record group into 2⁰ part, 2¹ parts, . . . , and 2ⁿ parts.

9. The data analysis method according to claim 1, wherein the correlation calculation step comprises a regression equation calculation step of calculating a regression equation of each of the subordinate record groups, and a contribution calculation step of calculating a contribution in each of the subordinate record groups.

10. The data analysis method according to claim 9, wherein a threshold of contribution can be specified in the execution control data input step, further comprising a result output step of outputting a correlation between variables only when the contribution becomes greater than or equal to the threshold.

11. A computer-readable recording medium recording a data analysis program for extracting a correlation among data, the data analysis program making a computer execute:
a record group sort step of sorting a target record group by a specified variable;
a record group divide-and-extract step of dividing the sorted target record group in a specified dividing manner and extracting subordinate record groups; and
a correlation calculation step of calculating a correlation between specified variables in each of the subordinate record groups.
